(19) United States
(12) Patent Application Publication
(10) Pub. No.: US 2006/0036897 A1
(43) Pub. Date: Feb. 16, 2006

(54) Data storage device

(76) Inventors: Chanson Lin, Jhubei City (TW); Chung Liang Lee, Jhubei City (TW); Ching Chung Hsu, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/983,692

(22) Filed: Nov. 9, 2004

(30) Foreign Application Priority Data
Aug. 13, 2004 (TW) 93124372

(51) Int. Cl. G06F 11/00

(52) U.S. Cl. 714/5; 711/103

(57) ABSTRACT

A data storage device comprises a flash memory controller having an interface controller, a buffer, a buffer management device, and a microcontroller therein. The interface controller receives several pieces of data and transfers them to the buffer management device, which temporarily stores the data into the buffer and can read/write data temporarily stored in the buffer. The microcontroller is connected between the buffer and the buffer management device for controlling actions between them. There is also a flash memory storage device with a flash array and an error correction code (ECC) controller therein. The flash array is connected to the buffer management device, and is used to receive and store data. The ECC controller is used to check and correct errors in data. The reliability and speed of data access can thus be enhanced, and bidirectional transmission can also be accomplished.

### FIELD OF THE INVENTION

The present invention relates to a data storage device and, more particularly, to a data storage device capable of enhancing the reliability and speed of data access.

### BACKGROUND OF THE INVENTION

In response to the development of many high-tech industries, many electronic products for processing data have been presented to the public. Today, people have more and more relied on electronic products for processing data, hence usually causing the occurrence of data loss. Therefore, it is necessary for modern people to consider seriously a good data storage device.

As shown in FIG. 1, a conventional data storage device comprises a host controller 101. The host controller comprises an application interface 102 for receiving data transferred from a host terminal 104. The application interface 102 transfers data to a controller 106 and then to a buffer 108 for temporary storage of data through the controller. The buffer 108 is connected to a buffer management device 110 and an error checking and correction (ECC) logic circuit 112. The buffer management device 110 can control data access of said buffer 108. The ECC logic circuit 112 is used to check and correct errors in data. The buffer 108 is connected to a flash array 114 for store data into the flash array 114.

The above data storage device, however, can only accomplish unidirectional transmission of data. That is, data can only be accessed by the host controller 101 to the flash array 112. Moreover, the speed of data access is very slow, and the reliability of data access is low.

### SUMMARY OF THE INVENTION

An object of the present invention is to provide a data storage device having a data encryption/decryption circuit controller is added in a flash memory controller to make data access safer, hence enhancing the reliability of data access.

Another object of the present invention is to provide a data storage device, wherein individual buffers can be disposed in a flash memory storage device to increase the speed of data access.

Yet another object of the present invention is to provide a data storage device to accomplish bidirectional transmission of data for overcoming the drawback of unidirectional transmission of data from the controller to the flash array in the prior art.

To achieve the above objects, the present invention proposes a data storage device, which comprises a flash memory controller and a flash memory storage device. The flash memory controller comprises an interface controller for receiving several pieces of data, a buffer for temporary storage of data, a buffer management device, and a microcontroller for controlling the buffer and the buffer management device. The buffer management device is connected to the interface controller and used to receive the data sent out by the interface controller for temporarily storing the data into the buffer. The buffer management device can also read/write data temporarily stored in the buffer. The flash memory storage device has a flash array and an error correction code controller connected to the flash array. The flash array is connected to the buffer management device and used to receive and store data through the buffer management device. The error correction code controller is used to check and correct errors in data.

The present invention also provides another data storage device, which comprises a flash memory controller and a flash memory storage device. The flash memory controller comprises an interface controller, a buffer, a buffer management device, and a microcontroller. The interface controller is used to receive several pieces of data and send them to the buffer management device. The buffer management device can temporarily store data into the buffer, and can also read/write data temporarily stored in the buffer. The microcontroller is connected between the buffer and the buffer management device for controlling actions between them. The flash memory storage device has a flash array and a double buffer connected to the flash array. The flash array is used to receive and store data transferred from the buffer management device. The double buffer is used to control the flash array for preventing overlap of data when the flash array receives data. The double buffer is also used to temporarily store data.

The present invention also provides yet another data storage device, which comprises a flash memory controller and a flash memory storage device. The flash memory controller comprises an interface controller, a buffer, a buffer management device, and a microcontroller. The interface controller is used to receive several pieces of data and send them to the buffer management device. The buffer management device can temporarily store data into the buffer, and can read/write data temporarily stored in the buffer. The microcontroller is connected between the buffer and the buffer management device for controlling actions between them. The flash memory storage device has a flash array, a finite state machine, and a control register. The flash array is used to receive and store data of the buffer management device. The control register is used to receive data of the buffer management device and send them to the flash array for storage. The finite state machine is connected to the flash array and the control register and used to perform read/write/erase actions to data.

The various objects and advantages of the present invention will be more readily understood from the following detailed description when read in conjunction with the appended drawing, in which:

### BRIEF DESCRIPTION OF THE DRAWINGS

FIG. 1 is a circuit block diagram of a conventional data storage device;

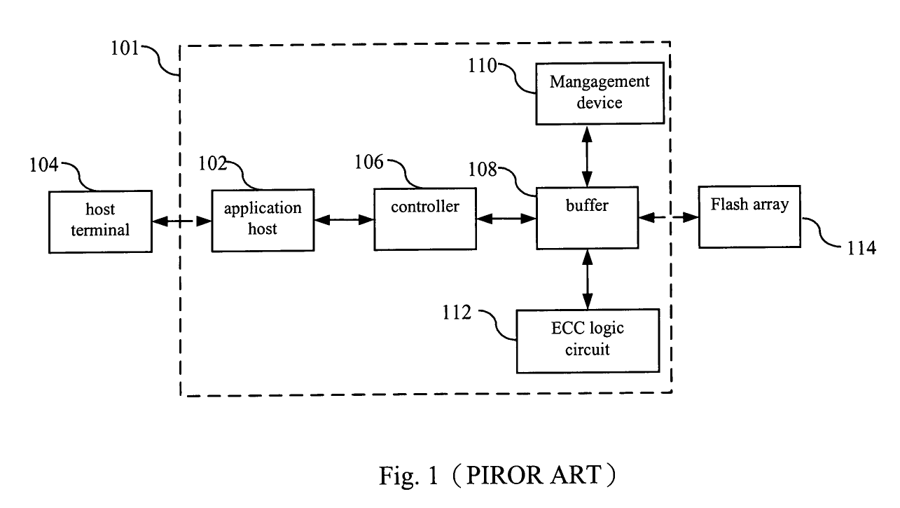

FIG. 2 is a circuit block diagram of a data storage device of the present invention;

FIG. 3 is a circuit block diagram of a data storage device according to another embodiment of the present invention;

FIG. 4 is a circuit block diagram of a data storage device according to another embodiment of the present invention;

FIG. 5 is a circuit block diagram of a data storage device according to another embodiment of the present invention;

FIG. 6 is a circuit block diagram of a data storage device according to another embodiment of the present invention;

FIG. 7 is a circuit block diagram of a data storage device according to another embodiment of the present invention;

FIG. 8 is a circuit block diagram of a data storage device according to another embodiment of the present invention;

FIG. 9 is a circuit block diagram of a data storage device according to another embodiment of the present invention;

FIG. 10 is a circuit block diagram of a data storage device according to another embodiment of the present invention;

FIG. 11 is a circuit block diagram of a data storage device according to another embodiment of the present invention;

FIG. 12 is a circuit block diagram of a data storage device according to another embodiment of the present invention; and

FIG. 13 is a circuit block diagram of a data storage device according to another embodiment of the present invention.

### DETAILED DESCRIPTION OF THE PREFERRED EMBODIMENTS

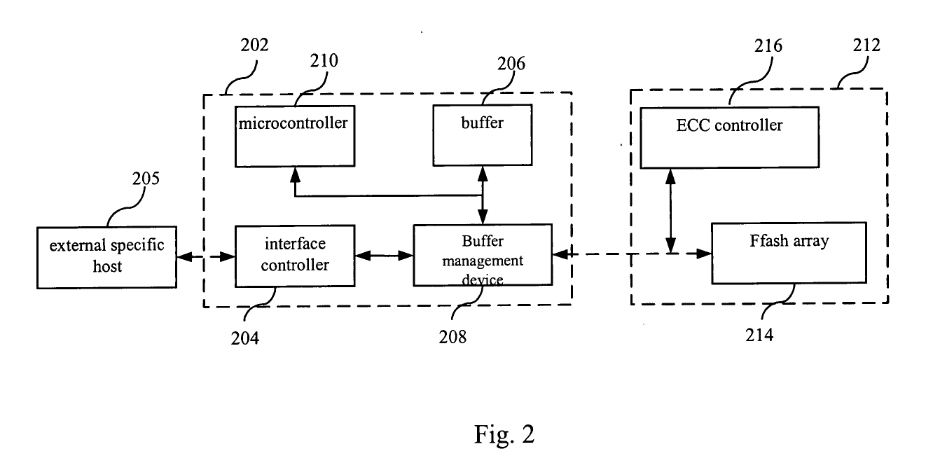

As shown in FIG. 2, the present invention proposes a data storage device comprising a flash memory controller 202 for data conversion and transmission. The flash memory controller 202 comprises an interface controller 204, a buffer 206, a buffer management device 208, and a microcontroller 210. The interface controller 204 is connected to an external specific host 205 for receiving data transferred from the external specific host 205 and sending them out. The buffer management device 208 is connected to the interface controller 204 and used to receive data sent out by the interface controller 204 and temporarily store them into the buffer 206. The buffer management device 208 can also read/write data temporarily stored in the buffer 206. A logical block to physical block mapping table is provided in the buffer management device 208 for recording access addresses of data. The flash memory controller 202 can also selectively increase the number of the buffer 206 for temporary storage of data. The microcontroller 210 is connected between the buffer 206 and the buffer management device 208 for controlling actions between them. There is also a flash memory storage device 212, which can perform data protection to blocks in a specific flash memory medium for avoiding damage due to error writing of data. The flash memory storage device 212 can also load in microcodes and store the microcodes into specific areas of a flash memory. The flash memory storage device 212 has a flash array 214 and an error correction code (ECC) controller 216 connected to the flash array 214. The flash array 214 is connected to the buffer management device 208 and used to receive and store data. The ECC controller 216 can check at least two bit errors and correct at least a bit error.

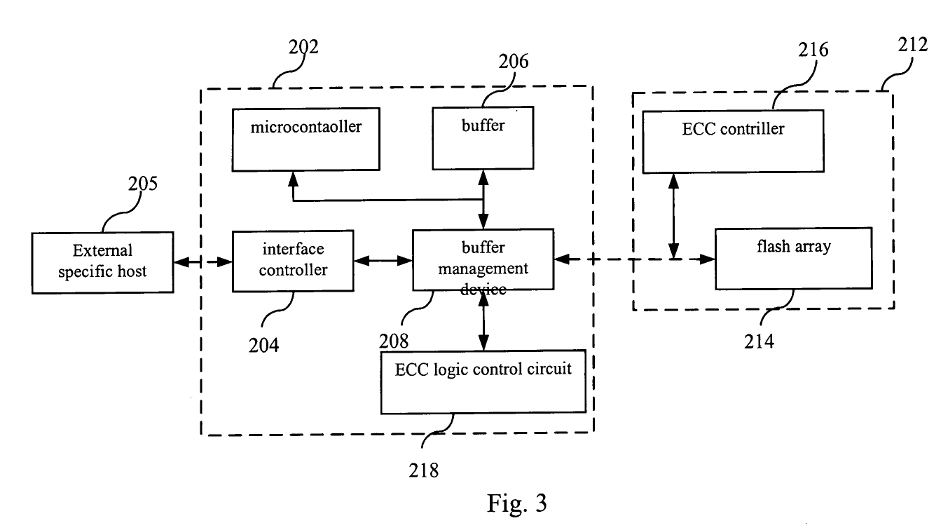

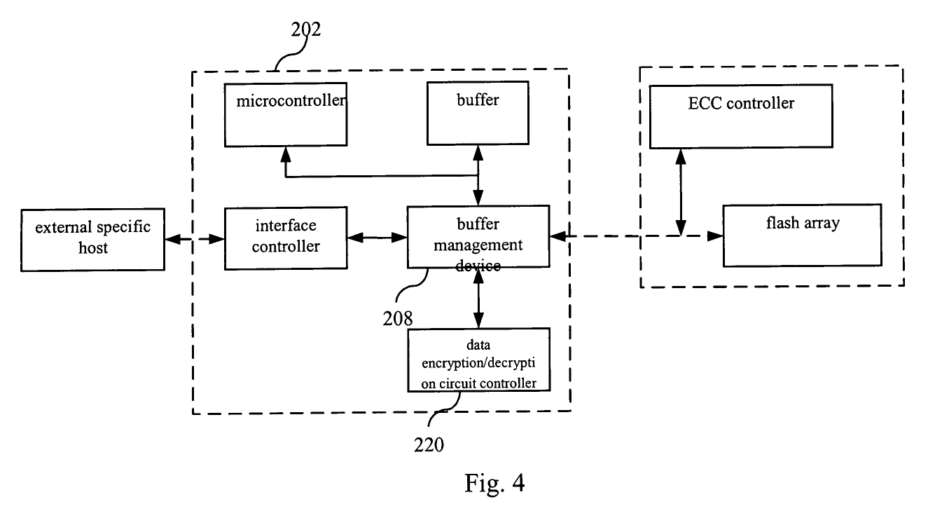

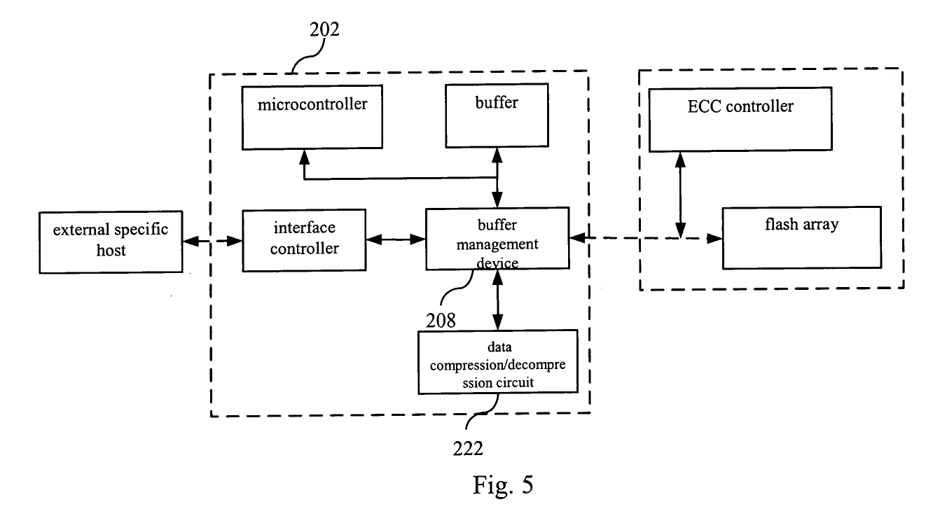

As shown in FIG. 3, an ECC control circuit 218 is disposed in the flash memory controller 202. The ECC control circuit 218 is connected to the buffer management device 208. When the buffer management device 208 reads/writes data temporarily stored in the buffer 206, the ECC control circuit 218 can check and correct errors in the data. Or the flash memory controller 202 can further comprise a data encryption/decryption circuit controller 220, as shown in FIG. 4. The data encryption/decryption circuit controller 220 is connected to the buffer management device 208 and used for data encryption/decryption to make data access safer, hence enhancing the reliability of data access. Or a data compression/decompression circuit 222 connected to the buffer management device 208 can be disposed in the flash memory controller 202, as shown in FIG. 5. The data compression/decompression circuit 222 is used for compression/decompression of data for shrinking the size of data after compression. When the data is to be read out, the data compression/decompression circuit 222 can perform decompression actions to the compressed data.

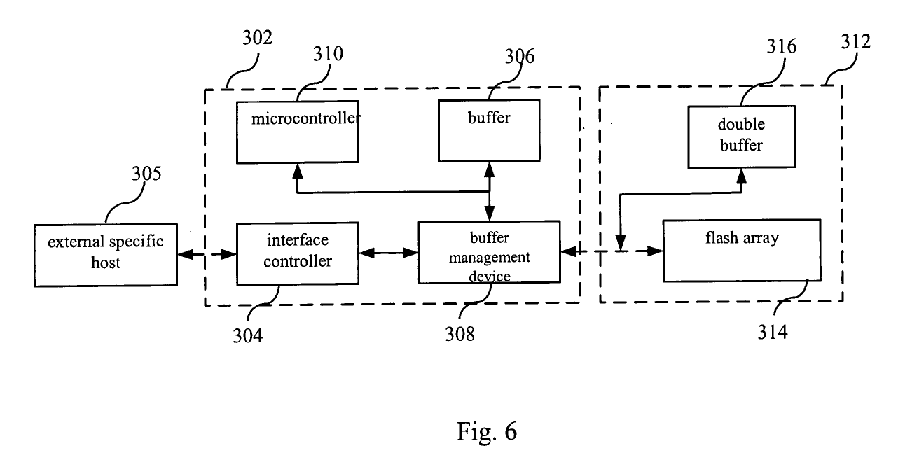

According to another embodiment of the present invention, a data storage device comprises a flash memory controller 302 for data conversion and transmission, as shown in FIG. 6. The flash memory controller 302 comprises an interface controller 304, a buffer 306, a buffer management device 308, and a microcontroller 310. The interface controller 304 is connected to an external specific host 305, which transfers data to the interface controller 304. The interface controller 304 is used to receive data and sending them out. The buffer management device 308 is connected to the interface controller 304 and used to receive data sent out by the interface controller 304 and temporarily store them into the buffer 306. The buffer management device 308 can also read/write data temporarily stored in the buffer 306. A logical block to physical block mapping table is provided in the buffer management device 308 for recording access addresses of data. The flash memory controller 302 can also selectively increase the number of the buffer 306 for temporary storage of data. The microcontroller 310 is connected between the buffer 306 and the buffer management device 308 for controlling actions between them. There is also a flash memory storage device 312, which can perform data protection to blocks in a specific flash memory medium for avoiding damage due to error writing of data. The flash memory storage device 312 can also load in microcodes and store the microcodes into specific areas of a flash memory. The flash memory storage device 312 has a flash array 314 and a double buffer 316 connected to the flash array 314. The flash array 314 is connected to the buffer management device 308 in the flash memory controller 302 and used to access data temporarily stored in the buffer 306 and store data through the buffer management device 308. The double buffer 316 is used to avoid overlap of data when the flash array 314 receives data. The double buffer is also used to temporarily store data, and can access data through the buffer management device 308.

The double buffer 316 can be two independent buffers connected to the flash array 314, respectively. If the two independent buffers are a first buffer and a second buffer, the first buffer and the second buffer are bridges between the buffer management device 308 and the flash array 314. The flash array 314 comprises two flash memory components a first flash memory component and a second flash memory component. The first buffer and the second buffer are connected to the first flash memory component and the second flash memory component, respectively. When writing in data, the buffer management device 308 to the first buffer and the second buffer to the second flash memory component can be performed simultaneously; or the buffer management device 308 to the second buffer and the first buffer to the first flash memory component can be performed simultaneously. When reading out data, the first buffer to the buffer management device 308 and the second flash memory component to the second buffer can be performed simultaneously; or the second buffer to the buffer management device 308 and the first flash memory component to the first buffer can be performed simultaneously. When reading out/writing in data as in the above way, the buffer management device 308 will first write data to the first buffer and then to the second buffer. Next, the first buffer and the second buffer will store data to the first flash memory component and the second flash memory component simultaneously, hence increasing the speed of data access.

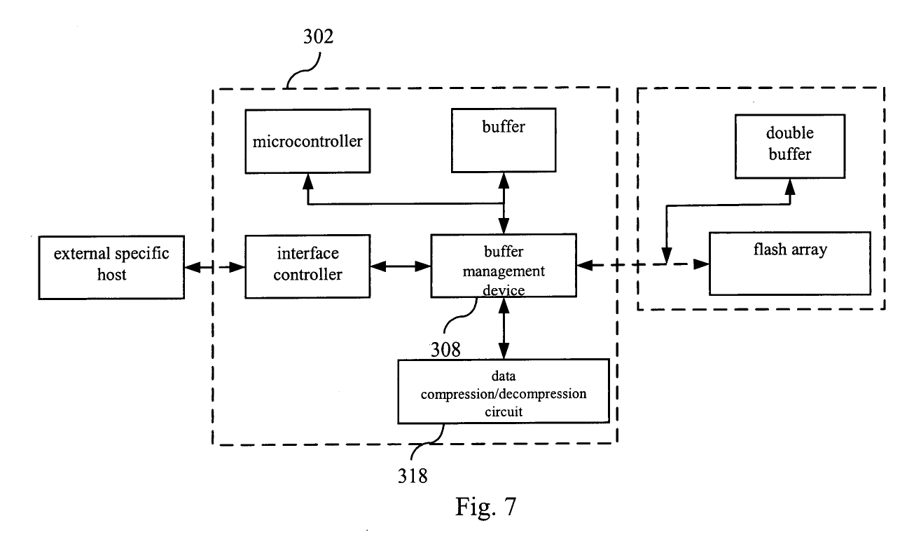

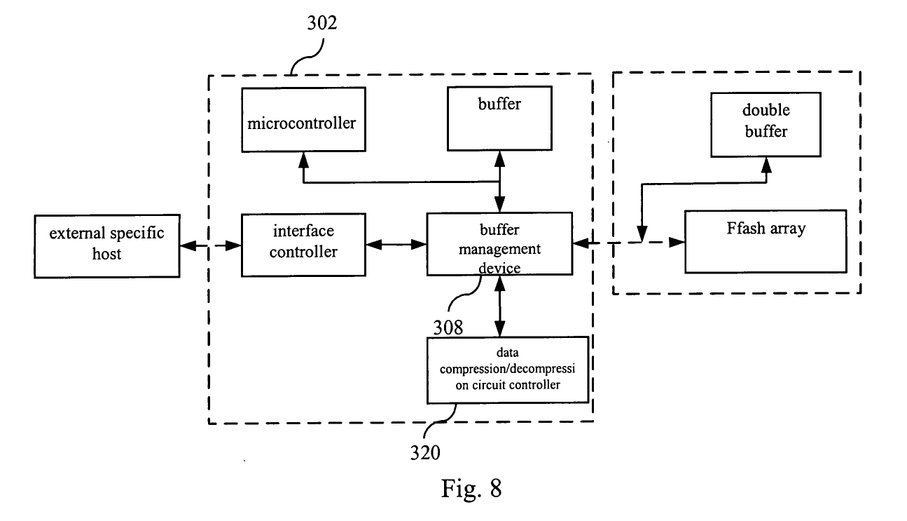

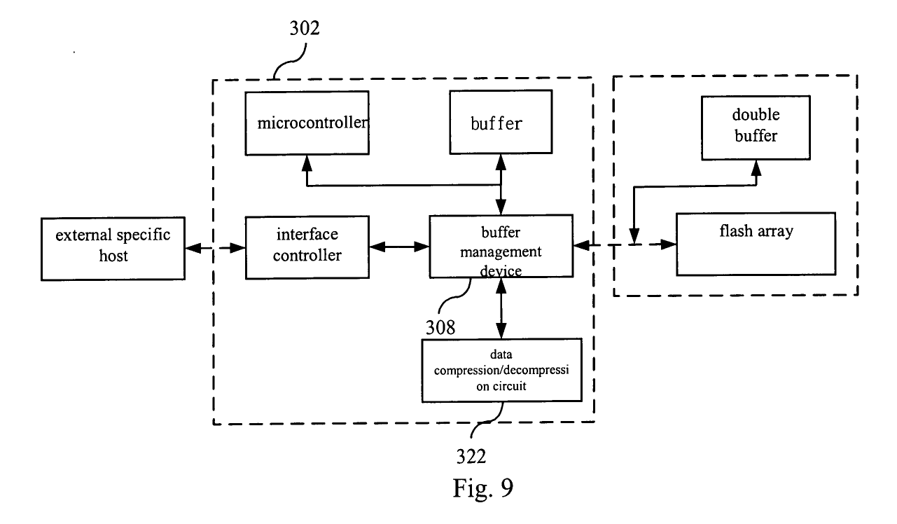

As shown in FIG. 7, an ECC control circuit 318 is disposed in the flash memory controller 302. The ECC control circuit 318 is connected to the buffer management device 308. When the buffer management device 308 reads/writes data temporarily stored in the buffer 306, the ECC control circuit 318 can check and correct errors in the data to ensure the correctness of data access. Or the flash memory controller 302 can further comprise a data encryption/decryption circuit controller 320 connected to the buffer management device 308, as shown in FIG. 8. The data encryption/decryption circuit controller 320 is used for data encryption/decryption. Or a data compression/decompression circuit 322 connected to the buffer management device 308 can be disposed in the flash memory controller 302, as shown in FIG. 9. The data compression/decompression circuit 322 is used for compression/decompression of data for shrinking the size of data after compression.

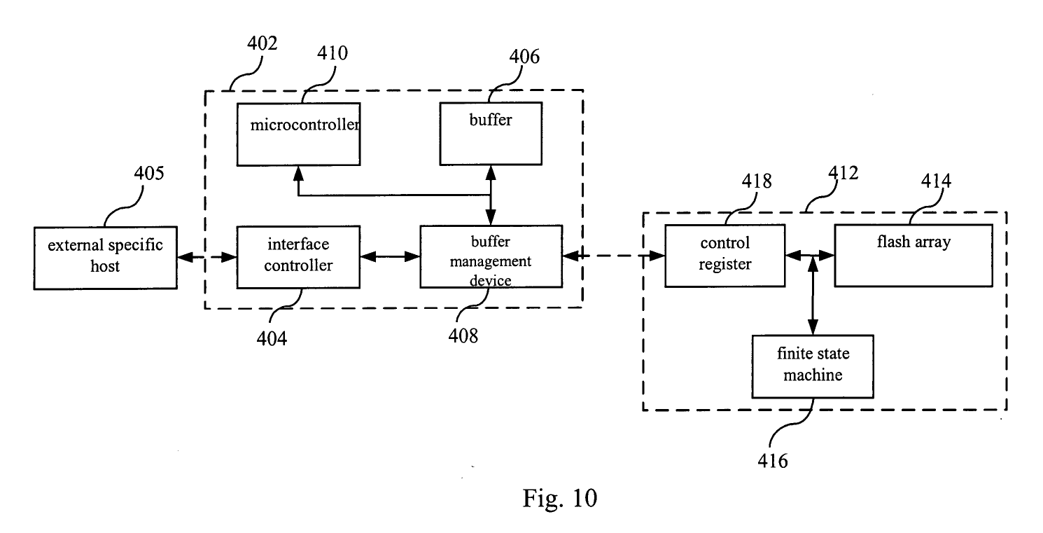

According to yet another embodiment of the present invention, a data storage device comprises a flash memory controller 402 for data conversion and transmission and a flash memory storage device 412, as shown in FIG. 10. The flash memory controller 402 comprises an interface controller 404, a buffer 406, a buffer management device 408, and a microcontroller 410. The interface controller 404 is connected to an external specific host 405 for receiving data transferred from the external specific host 405 and sending them out. The buffer management device 408 is connected to the interface controller 404 and used to receive data sent out by the interface controller 404 and temporarily store them into the buffer 406. The buffer management device 408 can also read/write data temporarily stored in the buffer 406. A logical block to physical block mapping table is provided in the buffer management device 408 for recording access addresses of data. The flash memory controller 402 can also selectively increase the number of the buffer 406 for temporary storage of data. The microcontroller 410 is connected between the buffer 406 and the buffer management device 408 for controlling actions between them. The flash memory storage device 412 can perform data protection to blocks in a specific flash memory medium for avoiding damage due to error writing of data. The flash memory storage device 412 can also load in microcodes and store the microcodes into specific areas of a flash memory. The flash memory storage device 412 has a flash array 414, a finite state machine 416, and a control register 418. The flash array 414 is connected to the buffer management device 408 in the flash memory controller 402 via the control register 418. The control register 418 is used to receive data transferred from the buffer management device 408 and send them to the flash array 414 for storage. The finite state machine 416 is connected to the flash array 414 and the control register 418 and used to perform read/write/erase actions to data in the flash array 414.

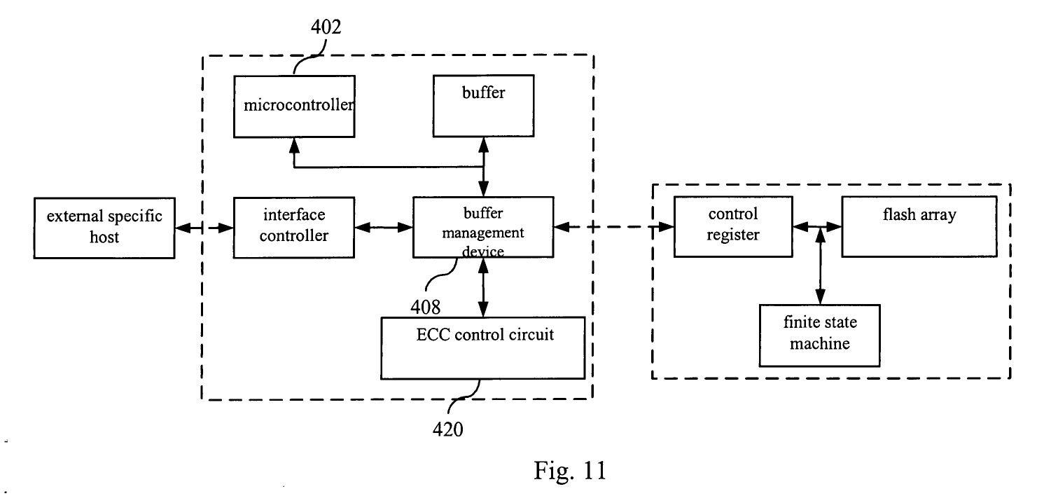

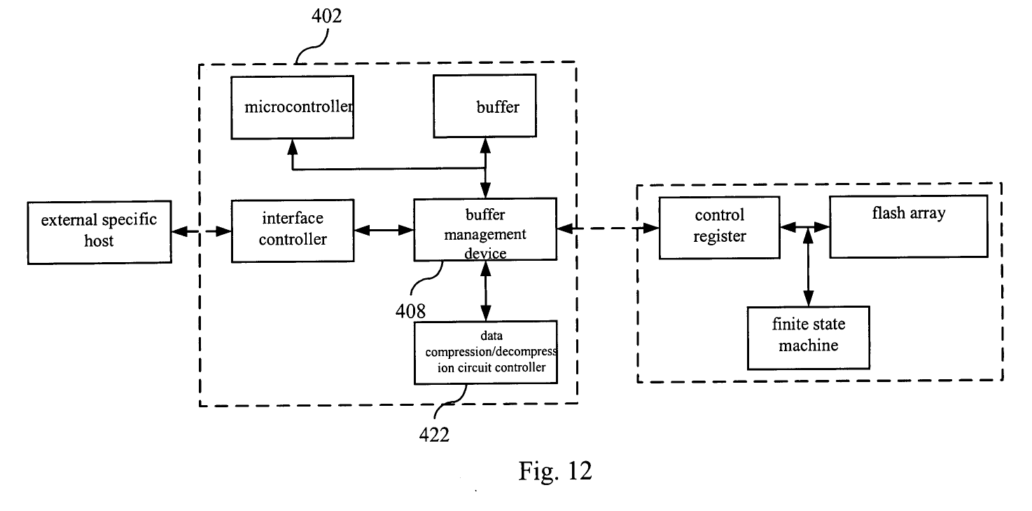

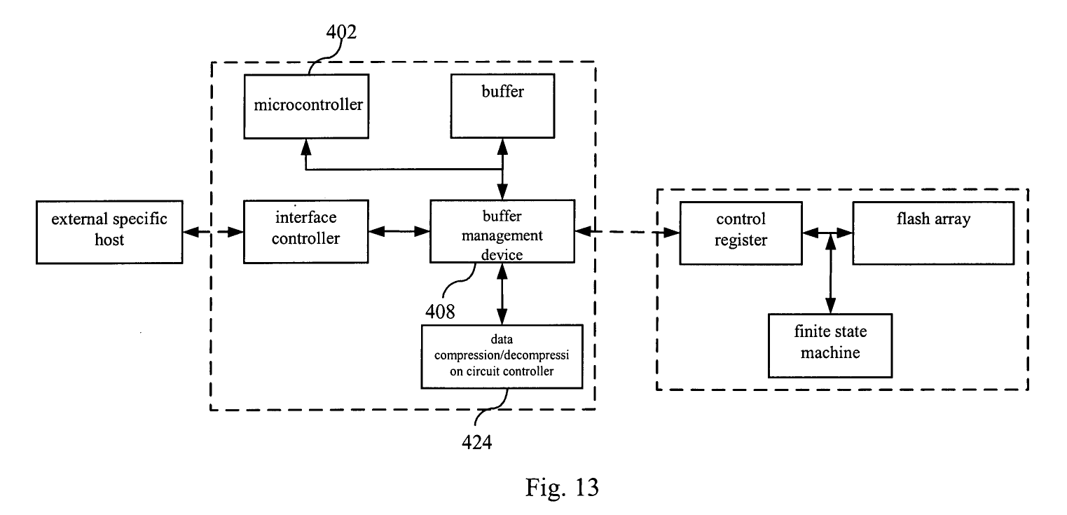

As shown in FIG. 11, an ECC control circuit 420 is disposed in the flash memory controller 402. The ECC control circuit 420 is connected to the buffer management device 408. When the buffer management device 408 reads/writes data temporarily stored in the buffer 406, the ECC control circuit 420 can check and correct errors in the data. Or the flash memory controller 402 can further comprise a data encryption/decryption circuit controller 422 connected to the buffer management device 408, as shown in FIG. 12. The data encryption/decryption circuit controller 422 is used for data encryption/decryption to make data access safer, hence enhancing the reliability of data access. Or a data compression/decompression circuit 424 connected to the buffer management device 408 can be disposed in the flash memory controller 402, as shown in FIG. 13. The data compression/decompression circuit 424 is used for compression/decompression of data when the buffer management device 408 accesses data.

To sum up, the present invention proposes a data storage device, which makes use of a data encryption/decryption circuit controller to make data access safer for enhancing the reliability of data access. An ECC controller is also used to check and correct errors in data for enhancing the correctness of data access. Moreover, a data compression/decompression circuit is made use of to shrink the size of data stored. Besides, a double buffer or independent buffers connected to a buffer management device in a flash memory controller can be disposed in a flash memory storage device so that bidirectional transmission of data can be accomplished between the flash memory controller and the flash memory storage device, hence overcoming the drawback of unidirectional transmission of data from the controller to the flash array in the prior art and also increasing the speed of data access.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A data storage device comprising:
a flash memory controller having an interface controller, a buffer, a buffer management device, and a microcontroller therein, said interface controller being used to receive several pieces of data and send them out, said buffer management device being connected to said interface controller and used to receive said data sent out by said interface controller for temporarily storing said data into said buffer, said buffer management device being able to read/write data temporarily stored in said buffer, said microcontroller being connected between said buffer and said buffer management device for controlling actions between them; and
a flash memory storage device having a flash array and an error correction code controller connected to said flash array, said flash array being connected to said buffer management device and used to receive and store said data, said error correction code controller being used to check and correct errors in said data.

2. The data storage device as claimed in claim 1, wherein said flash memory controller further comprises an error correction code control circuit, which is connected to said buffer management device and used for error checking and correction of said data.

3. The data storage device as claimed in claim 1, wherein said flash memory controller further comprises a data encryption/decryption circuit controller, which is connected to said buffer management device and used for encryption/decryption of said data.

4. The data storage device as claimed in claim 1, wherein said flash memory controller further comprises a data compression/decompression circuit, which is connected to said buffer management device and used for compression/decompression of said data.

5. The data storage device as claimed in claim 1, wherein said buffer management device has a logical block to physical block mapping table for recording access addresses of said data.

6. A data storage device comprising:
a flash memory controller comprising an interface controller, a buffer, a buffer management device, and a microcontroller, said interface controller being used to receive several pieces of data and send them out, said buffer management device being connected to said interface controller and used to receive said data sent out by said interface controller for temporarily storing said data into said buffer, said buffer management device being able to read/write data temporarily stored in said buffer, said microcontroller being connected between said buffer and said buffer management device for controlling actions between them; and
a flash memory storage device having a flash array and a double buffer connected to said flash array, said flash array being connected to said buffer management device and used to receive and store said data, said double buffer being used to control said flash array for preventing overlap of said data when said flash array receives said data, said double buffer being also used to temporarily store said data.

7. The data storage device as claimed in claim 6, wherein said double buffer comprises a first buffer and a second buffer, said flash array comprises a first flash memory component and a second flash memory component, and said first buffer and said second buffer are connected to said first flash memory component and said second flash memory component to process said data for increasing the speed of access, respectively.

8. The data storage device as claimed in claim 7, wherein said first buffer can read said data stored in said second flash memory component, and said second buffer can read said data stored in said first flash memory component.

9. The data storage device as claimed in claim 6, wherein said flash memory controller further comprises an error correction code control circuit, which is connected to said buffer management device and used for error checking and correction of said data.

10. The data storage device as claimed in claim 6, wherein said flash memory controller further comprises a data encryption/decryption circuit controller, which is connected to said buffer management device and used for encryption/decryption of said data.

11. The data storage device as claimed in claim 6, wherein said flash memory controller further comprises a data compression/decompression circuit, which is connected to said buffer management device and used for compression/decompression of said data.

12. The data storage device as claimed in claim 6, wherein said buffer management device has a logical block to physical block mapping table for recording access addresses of said data.

13. The data storage device as claimed in claim 6, wherein said interface controller provides connection with an external specific host for receiving said data of said external specific host.

14. A data storage device comprising:
a flash memory controller comprising an interface controller, a buffer, a buffer management device, and a microcontroller, said interface controller being used to receive several pieces of data and send them out, said buffer management device being connected to said interface controller and used to receive said data sent out by said interface controller for temporarily storing said data into said buffer, said buffer management device being able to read/write data temporarily stored in said buffer, said microcontroller being connected between said buffer and said buffer management device for controlling actions between them; and
a flash memory storage device having a flash array, a finite state machine, and a control register, said flash array being connected to said buffer management device and used to receive and store said data, said control register being connected to said buffer management device and said flash array and used to receive said data of said buffer management device and send them to said flash array, said finite state machine being connected to said flash array and said control register and used to perform read/write/erase actions of said flash array to said data.

15. The data storage device as claimed in claim 14, wherein said flash memory controller further comprises an error correction code control circuit, which is connected to said buffer management device and used for error checking and correction of said data.

16. The data storage device as claimed in claim 14, wherein said flash memory controller further comprises a data encryption/decryption circuit controller, which is connected to said buffer management device and used for encryption/decryption of said data.

17. The data storage device as claimed in claim 14, wherein said flash memory controller further comprises a data compression/decompression circuit, which is connected to said buffer management device and used for compression/decompression of said data.

18. The data storage device as claimed in claim 14, wherein said buffer management device has a logical block to physical block mapping table for recording access addresses of said data.
